(19) United States
(12) Patent Application Publication
(10) Pub. No.: US 2013/0264506 A1
(43) Pub. Date: Oct. 10, 2013

(54) SOLENOID VALVE

(71) Applicants: Franz-Josef Schnelker, Neuss (DE); Werner Buse, Kaarst (DE); Christoph Sadowski, Bochum (DE); Rolf Lappan, Koeln (DE); Rolf Dohrmann, Kaarst (DE)

(72) Inventors: Franz-Josef Schnelker, Neuss (DE); Werner Buse, Kaarst (DE); Christoph Sadowski, Bochum (DE); Rolf Lappan, Koeln (DE); Rolf Dohrmann, Kaarst (DE)

(21) Appl. No.: 13/994,131

(22) PCT Filed: Nov. 15, 2011
(86) PCT No.: PCT/EP11/70121

§ 371 Date: Jun. 14, 2013

(30) Foreign Application Priority Data
Dec. 17, 2010 (DE) 10-2010-055-035.3

(51) Int. Cl. F16K 31/04

(52) U.S. Cl. CPC F16K 31/04
USPC 251/129.15

(57) ABSTRACT

A solenoid valve includes a valve sleeve comprising a valve seat, a valve closure element which acts on the valve seat, and a housing. Within the housing is arranged a coil, a moveable armature, a core, and a multiple-part return-path arrangement, which together form an electromagnetic circuit. The core is arranged on a side of the housing opposite to the valve sleeve. The coil is wound onto a coil former. The coil former is formed as the valve sleeve and comprises a first portion with an inner diameter. The coil former is arranged on a side of the housing opposite to the core. The armature is mounted in the coil former via a bearing device and acts on the valve closure element. The armature comprises a first part directed towards the core having a diameter which is larger than the inner diameter of the first portion of the coil former.

### CROSS REFERENCE TO PRIOR APPLICATIONS

This application is a U.S. National Phase application under 35 U.S.C. §371 of International Application No. PCT/EP2011/070121, filed on Nov. 15, 2011 and which claims benefit to German Patent Application No. 10 2010 055 035.3, filed on Dec. 17, 2010. The International Application was published in German on Jun. 21, 2012 as WO 2012/079889 A1 under PCT Article 21(2).

### FIELD

The present invention refers to a solenoid valve having a housing, in which a coil which is wound onto a coil former, an armature, a core, and a multiple-part return-path arrangement are arranged, which form an electromagnetic circuit, wherein the movable armature is mounted in the coil former via bearing means and acts directly or indirectly on at least one valve closure element, wherein the valve closure element acts on at least one valve seat which is arranged in a valve sleeve.

### BACKGROUND

various fields of application in internal combustion machines. Solenoid valves are used both in pneumatic and in hydraulic circuits in vehicles, such as in brake equipment, brake systems or injection systems. They can moreover be used to control the pressure of pneumatic actuators or as divert-air valves in turbochargers, for example. Depending on the field of application, these solenoid valves are configured either as open/close valves or as proportional control valves.

A solenoid valve designed as a pressure control valve is, for example, described in DE 10 2007 002 465 A1. Here, the pressure control valve has an electromagnetic part that is to be adjusted, calibrated and assembled as accurately as possible. This pressure control valve, however, still comprises a great number of components that make an optimization of the manufacture seem rather improbable with respect to pre-assembly and final assembly. This document moreover does not describe how to realize the connection between the valve plunger and the armature. In this context, however, a high degree of coaxiality between the armature and the valve plunger is a precondition for a perfect operation of the pressure control valve. The embodiment according to DE 10 2007 002 465 A1, however, bears a risk of causing coaxiality errors between the armature and the valve plunger.

### SUMMARY

An aspect of the present invention is to provide a solenoid valve that avoids the disadvantages mentioned above.

In an embodiment, the present invention provides a solenoid valve which includes a valve sleeve comprising at least one valve seat, at least one valve closure element configured to act on the at least one valve seat, and a housing. Within the housing is arranged a coil, a moveable armature, a core, and a multiple-part return-path arrangement, which together form an electromagnetic circuit. The core is arranged on a side of the housing opposite to the valve sleeve. The coil is wound onto a coil former. The coil former is formed as the valve sleeve and comprises a first portion with an inner diameter. The coil former is arranged on a side of the housing opposite to the core. A movable armature is mounted in the coil former via a bearing device and acts directly or indirectly on the at the least one valve closure element. The armature comprises a first part directed towards the core having a diameter. The diameter of the first part is larger than the inner diameter of the first portion of the coil former.

### BRIEF DESCRIPTION OF THE DRAWINGS

The present invention is described in greater detail below on the basis of embodiments and of the drawing in which:

FIG. 1 shows an embodiment of a solenoid valve of the present invention.

### DETAILED DESCRIPTION

In an embodiment of the present invention, a solenoid valve includes a core arranged on a side of the housing opposite the valve sleeve and an armature formed from a plurality of parts, where a first part, facing towards the core, has a diameter larger than the inner diameter of a portion of a coil former, and wherein the coil former is configured as a valve sleeve on a side opposite the core. In terms of manufacturing technology, it is advantageous if at least parts of the return-path arrangement are arranged in the coil former. For a positionally accurate assembly of the core, it is advantageous if a portion of the core opposite the armature has a diameter larger than a portion of the coil former opposite the valve closure element. A valve plunger is advantageously guided in the valve sleeve, which plunger is connected with the armature. Under assembly aspects and in the interest of avoiding coaxiality errors, it is advantageous if the armature and the valve plunger are formed integrally.

For a further improvement of the coaxiality, said portion of the coil former comprises a bearing sleeve for the armature. In an embodiment of the present invention, said portion of the coil former is configured as a bearing region for the armature. The coil former may be manufactured by an injection molding process, with the coil former advantageously being formed from a dimensionally and temperature stable material, such as, for example, Grivory® HT2V 3HLV or Grivory® XE3881.

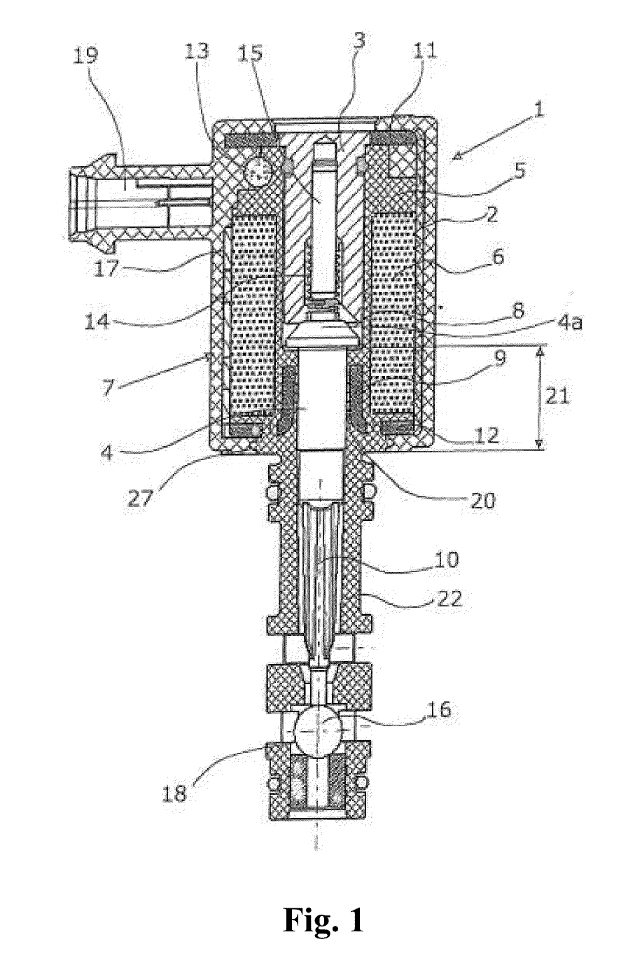

A solenoid valve 1, illustrated in FIG. 1, comprises a housing 2, in which a core 3, an armature 4, a coil former 5 with a coil 6 wound thereon, and a return-path arrangement 7 are disposed. In an embodiment of the present invention, the armature 4 is connected integrally with a valve plunger 10 that acts on a valve closure element 16 in a manner known per se. The valve plunger 10 is here guided in a valve sleeve 22 formed on a side of the coil former 5 opposite the core and is connected integrally therewith. A solenoid valve 1 of such configuration is used as an oil pressure control valve. The valve closure element 16 acts on at least one valve seat 18 which is arranged in a valve sleeve 22.

Such a solenoid valve operates as follows: In the de-energized state, a gap 8 exists between the armature 4 and the core 3 in which a magnetic field is generated when the coil 6 is energized, whereby an axial movement of the armature 4 is caused. The valve plunger 10 connected with the armature 4 is also correspondingly moved and the valve closure element 16 is released. The coaxial arrangement of the armature is therefore important for an optimal functioning of the solenoid valve.

In an embodiment of the present embodiment, a return-path inner section 9 is formed integrally with the return-path cover section 12 averted from the core 3, and is arranged in a manner integrated in the coil housing 5. The return-path inner and cover sections 9, 12 were hereincluded when the coil former 5 was manufactured in an injection molding process. An interference suppression resistance 13 is further already provided in the coil former 5. Essential components can be provided in the coil former 5 during pre-assembly in this manner. During the manufacture of a standard coil component, it is thus only necessary to select the coil 6 chosen for the valve function and to mount it on the coil former 5. After the second return-path cover section 11 has been placed and the return-path side section 17 has been engaged in a pressed connection with the return-path cover sections 11, 12 such that an electromagnetic circuit can be formed, and the contacting with an electric plug 19 has been made, the solenoid valve 1 is finished by being overmolded with the outer housing 2. In doing so, a contour is provided between the outer housing 2 and the coil former 5 which provides a kind of labyrinth-like seal 27 to increase the effect of sealing from the atmosphere.

In an embodiment of the present invention, the solenoid valve is then finished by arranging the core 3, the armature 4 and the associated components, such as a spring 14 that, in the present case, maintains the armature 4 under a bias, as well as a stop pin 15 adjustably provided in the core 3. It is here useful for positioning if a portion of the core 3 opposite the armature 4 has a larger diameter than a portion of the coil former 5 opposite the valve closure element 16.

In an embodiment of the present invention, bearing means 20 for the armature 4 are formed by the coil former 5, the bearing region 21 substantially coinciding with the region in which the return-path inner section 9 is provided. This embodiment becomes possible due to the fact that a first part 4a of the armature, facing towards the core, has a diameter that is larger than the inner diameter of a portion 21 of the coil former 5. Besides the great advantage with respect to assembly, this is advantageous in that the bearing region 21 of the coil former 5 is positively reinforced by the inclusion of the return-path inner section 9. By applying a sliding layer in the bearing region 21, it is provided that the armature slides in the coil former with as little resistance as possible. The coaxial guiding of the armature 4 in the solenoid valve is provided by the double function of the coil former 5 which, on the one hand, receives the core 3 and, on the other hand, acts as bearing means for the armature 4. It is also possible to provide a bearing bushing in the region 21.

Coaxiality errors can be excluded due to the fact that a part of the coil former 5 is configured as a valve sleeve 22 for the valve plunger 10 integrally connected with the armature 4. The armature 4 and the valve plunger 10 do not necessarily have to be formed integrally and may also be coupled with each other by a form-fit or force-fit connection in an embodiment.

The coil former 5 can be formed from a dimensionally and temperature stable material such as, for example, Grivory® HT2V 3HLV, Grivory® XE388, PPA or PA 4.6.

The present invention is not limited to embodiments described herein; reference should be had to the appended claims.

What is claimed is:

1-9. (canceled)

10. A solenoid valve comprising:
a valve sleeve comprising at least one valve seat;
at least one valve closure element configured to act on the at least one valve seat; and
a housing within which is arranged:
a core arranged on a side of the housing opposite to the valve sleeve,
a coil wound onto a coil former, the coil former being formed as the valve sleeve and comprising a first portion with an inner diameter, the coil former being arranged on a side of the housing opposite to the core;
an armature configured to be movable mounted in the coil former via a bearing device and to act directly or indirectly on the at the least one valve closure element, the armature comprising a first part directed towards the core having a diameter, the diameter of the first part being larger than the inner diameter of the first portion of the coil former, and
a multiple-part return-path arrangement,
wherein, the coil, the moveable armature, the core, and the multiple-part return-path arrangement together form an electromagnetic circuit.

11. The solenoid valve as recited in claim 10, wherein a part of the multiple-part return-path arrangement is disposed in the coil former.

12. The solenoid valve as recited in claim 11, wherein the coil former further comprises a second portion with a diameter opposite to the valve closure element, and wherein a portion of the core arranged opposite to the armature comprises a diameter which is larger than the diameter of the second portion of the coil former arranged opposite to the valve closure element.

13. The solenoid valve as recited in claim 10, further comprising a valve plunger connected with the armature, the valve plunger being configured to be guided in the valve sleeve.

14. The solenoid valve as recited in claim 10, wherein the armature and the valve plunger are integrally formed.

15. The solenoid valve as recited in claim 10, wherein the first portion of the coil former includes a bearing sleeve for the armature.

16. The solenoid valve as recited in claim 10, wherein the first portion of the coil former is configured as a bearing region for the armature.

17. The solenoid valve as recited in claim 10, wherein the coil former is formed using an injection molding process.

18. The solenoid valve as recited in claim 10, wherein the coil former is formed from a dimensionally and temperature stable material.

19. The solenoid valve as recited in claim 20, wherein the dimensionally and temperature stable material is selected from Grivory® HT2V-3H LF or Grivory® XE3881.
